(19) United States
(12) Patent Application Publication
(10) Pub. No.: US 2006/0151382 A1
(43) Pub. Date: Jul. 13, 2006

(54) Contact devices with nanostructured materials

(76) Inventor: Viktor I. Petrik, S. Petersburg (RU)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/035,110

(22) Filed: Jan. 12, 2005

(51) Int. Cl. B01D 71/00

(52) U.S. Cl. 210/490; 210/500.21; 210/500.25; 210/503; 210/506; 96/4; 96/9; 55/486

(57) ABSTRACT

A device includes a non-porous carbonaceous and nanostructured material other than a carbon nanotube, wherein the smallest dimension of the material is less than 100 nm. In most preferred devices, the carbonaceous material comprises graphene that is retained by a second material, wherein the device is configured as a filter for a gas and/or a liquid.

### FIELD OF THE INVENTION

The field of the invention is devices comprising carbon nanostructures other than carbon nanotubes.

### BACKGROUND OF THE INVENTION

Activated charcoal is a common sorbent for numerous compounds and has been used in a large variety of filters, including potable water and air filtration. Among other advantages, such charcoal is relatively inexpensive, biologically inert and non-toxic, and can be easily disposed of. However, despite numerous desirable properties, activated charcoal has several disadvantages.

For example, the sorption capacity of activated charcoal is relatively limited and typically determined by the pore size and volume. Moreover, not all compounds are retained by activated charcoal. Still further, most activated charcoal preparations are at least somewhat hydrophilic and therefore suffer from loss of capacity where the activated charcoal is used in a humid or aqueous environment.

To circumvent at least some of the above disadvantages, single-wall carbon nanotubes (SWNT) or multi-wall carbon nanotubes (MWNT) can be employed as sorbing agents. While SWNT and MWNT often exhibit superior sorbent characteristics as compared to activated charcoal, various new disadvantages arise. Most significantly, the substantial cost of industrial scale production is often prohibitive for use of such nanotubes in filtration devices. Furthermore, and especially where the nanotubes need to be assembled to a filtration element, manufacture of such elements remains a largely academic endeavor.

Therefore, while various materials and methods for devices with relatively small sorbents are known in the art, all or almost all of them suffer from one or more disadvantages. Thus, there is still a need to provide improved devices and methods for manufacture of devices, and especially those comprising carbon nanostructures.

### SUMMARY OF THE INVENTION

The present invention is directed to devices and methods that include a non-porous carbonaceous material (preferably other than a carbon nanotube and/or a fullerene) having a smallest dimension of less than 100 nm, wherein a second material is associated with the carbonaceous material such that the second material retains at least a portion of the carbonaceous material on or in the second material. In one aspect of the inventive subject matter, the smallest dimension is less than 50 nm, more preferably less than 10 nm, and most preferably comprises at least 0.1 wt % graphene.

In another aspect of the inventive subject matter, the non-porous carbonaceous material is embedded within, enclosed within, or coated onto the second material. The second material is preferably a sol-gel material, fabric, synthetic or natural polymer, glass, semiconductor, and/or a metal, and even more preferably permeable to a liquid and/or gas. Therefore, in further preferred aspects, contemplated devices are configured as a flow-through air- or water filter.

Therefore, in still other aspects of the inventive subject matter, a filter comprises a non-porous carbonaceous material other than a carbon nanotube in which the smallest dimension is less than 100 mm, wherein a second material retains the carbonaceous material while the filter is in contact with at least one of a gas and a liquid.

Various objects, features, aspects and advantages of the present invention will become more apparent from the figures and the following detailed description of preferred embodiments of the invention.

### DETAILED DESCRIPTION

The inventors have discovered that nanostructured materials, and especially non-porous carbonaceous materials with a smallest dimension of equal or less than 100 nm can be included in a material to form numerous desirable devices. Among other contemplated advantages, such devices are thought to impart superior adsorbing properties, conductivity, chemical resistance to oxidation, structural stability, etc. Most preferably, contemplated devices include graphene in an amount of at least 0.01 wt %, more typically at least 0.1 wt %, even more typically at least 1-10 wt %, and most more typically at least 10-95 wt %, and even more.

As used herein, the term “graphene” refers to a molecule in which a plurality of carbon atoms (e.g., in the form of five-membered rings, six-membered rings, and/or seven-membered rings) are covalently bound to each other to form a (typically sheet-like) polycyclic aromatic molecule. Consequently, and at least from one perspective, a graphene may be viewed as a single layer of carbon atoms that are covalently bound to each other (most typically Sp bonded). It should be noted that such sheets may have various configurations, and that the particular configuration will depend (among other things) on the amount and position of five-membered and/or seven-membered rings in the sheet. For example, an otherwise planar graphene sheet consisting of six-membered rings will warp into a cone shape if a five-membered ring is present the plane, or will warp into a saddle shape if a seven-membered ring is present in the sheet. Furthermore, and especially where the sheet-like graphene is relatively large, it should be recognized that the graphene may have the electron-microscopic appearance of a wrinkled sheet. It should be further noted that under the scope of this definition, the term “graphene” also includes molecules in which several (e.g., two, three, four, five to ten, one to twenty, one to fifty, or one to hundred) single layers of carbon atoms (supra) are stacked on top of each other to a maximum thickness of less than 100 nanometers. Consequently, the term “graphene” as used herein refers to a single layer of aromatic polycyclic carbon as well as to a plurality of such layers having a thickness of less than 100 nanometers. Typically, the dangling bonds on the edge of the graphene are saturated with a hydrogen atom. The term “about” where used in conjunction with a numeral refers to a numeric range of +/−10% of the numeral, inclusive. For example, the term “about 100” refers to a numerical value of between 90 and 110, inclusive.

As yet further used herein, the term “non-porous” in conjunction with a material refers to a porosity (i.e., void space within the material itself) of the material of less than 5 vol %, and even more typically of less than 2 vol %. For example, a material having a total volume of 10 cubic micrometer is considered non-porous is that material has a total pore volume of less than 0.5 cubic micrometer. It should be noted that the annular space defined by a carbocyclic ring is not considered a pore under the definition provided herein. Also, where a material has a contorted shape (e.g., a graphene in a wrinkled, sheet-like configuration) within a given volume, the void space between the material in that volume is not considered a pore under the definition provided herein.

As further used herein, the term “carbon nanotube” refers to a cylindrical single- or multi-walled structure in which the wall(s) is (are) predominantly composed of carbon, wherein the diameter may be uniform or decreasing over the length of the nanotube. In some instances, the carbon nanotube can be curved, and is therefore also termed “carbon nanohorn”.

In one preferred aspect of the inventive subject matter, the inventors contemplate that the carbonaceous material is a bulk graphene preparation that is commercially available (e.g., from SupraCarbonic, 1030 West 17th Street, Costa Mesa, Calif. 92627). Alternatively, contemplated graphene composition may also be prepared from graphite, coal, tar, etc. as described in our copending application with the Ser. No. 11/007,614, which is incorporated by reference herein. Depending on the starting material, reaction conditions, and other parameters, the non-porous carbonaceous material will typically have a smallest dimension of less than 100 nm, more typically less than 50 nm, and most typically less than 10 nm. It should be noted that (similar to purified carbon nanotubes) a significant fraction of the graphene material will aggregate to form a light-weight material in which the graphene layers typically have a contorted configuration. Where more disaggregated material or even isolated graphene layers are desired, it should be recognized that the aggregated material may be dispersed using chemical and/or physical treatments (e.g., one or more solvents, heat, microwave radiation, and/or ultrasound irradiation).

For example, suitable solvents include various amides, alcohols, benzene, acetone, those described in US2003/0001141 (incorporated by reference herein), and mixtures thereof. With respect to heat treatment, it should be noted that the temperature is at least to some degree dependent on the environment in which the graphene preparation is present. For example, where the graphene is in a solvent, the upper temperature is typically determined by the boiling point under normal pressure. However, higher temperatures may also be used at elevated pressure. Similarly, lower temperatures are also deemed suitable. Where the environment is an oxygen-containing gas phase and dangling bonds are present, it is typically preferred that the temperature is below 400° C. However, higher temperature (e.g., between 400° C. and 1000° C., or between 1000° C. and 3000° C.) are also contemplated. Microwave and/or ultrasound irradiation are typically performed using energies of less than 1000 W over a period of time that is non-destructive to the graphene material, and it should be recognized that the proper conditions can be readily determined (e.g., using SEM or TEM) without undue experimentation.

Still further contemplated alternative suitable materials include carbon fractals, branched nanotubes, and other irregularly shaped carbonaceous material so long as such material is non-porous and has a smallest dimension of less than 100 nm. Exemplary materials are disclosed in in our copending application with the Ser. No. 11/007,614 (supra). Additionally, it should be appreciated that the materials contemplated herein may be derivatized in numerous manners, and especially contemplated derivatizations include metal deposition (and especially with noble metals), derivatization with elements or compounds that produce semi-conductor characteristics (e.g., boron doped), and chemical modification of one or more carbon atoms within the graphene plane and/or edge. Most preferably, metal deposition is performed in which the metal provided from a gas phase (e.g., CVD, PVD, etc.), but other forms are also deemed suitable, including electroless deposition, electrolytic deposition, etc. Chemical modification of the graphene will generally follow known procedures for chemical derivatization of carbon nanotubes, which is well known in the art (e.g., exemplary covalent derivatization methods are described in J. Mater. Res., Vol. 13, No. 9, (1998) p2423-2431; in Chem. Eur. J. 2003, 9, 4000-4008, or in U.S. Pat. Nos. 6,187,823, 6,426,134, WO 98/39250, and WO 00/17101, all of which are incorporated by reference herein). Non-covalent derivatization may be achieved by adding derivatized polycyclic aromatic compounds to the graphene compositions to achieve Van-der-Waals anchoring to the graphene.

Depending on the particular use, it should be recognized that the non-porous carbon composition may be at least partially disaggregated (e.g., to provide isolated graphene layers via solvent disaggregation and dilution), at least partially aggregated (e.g., to increase particle size), compacted, or even compressed to form a solid material that can be further reshaped if desired.

Where the carbonaceous material is derivatized, it should be recognized that the derivatization groups may be employed to crosslink the carbonaceous material, or to covalently or non-covalently bind the carbonaceous material to another material. Furthermore, and especially where a relatively low density of the carbonaceous material is desirable, hydrophobic and/or hydrophilic fillers may be admixed to the carbonaceous material. For example, suitable fillers include glass fibers, polymeric fibers, vermiculite, fumed silica, mineral products (e.g., clay, carbonates, . . . ), etc. While not limiting to the inventive concept presented herein, it is typically preferred that the carbonaceous non-porous material is used in bulk quantities, which are typically quantities of at least 0.5 gram, more typically at least 5 gram, even more typically at least 50 gram, and most 2.5 typically at least 500 gram.

With respect to the second material that retains at least part of contemplated non-porous carbonaceous material, it should be recognized that numerous materials are deemed suitable for use herein, and the particular use and manner of retaining will at least in part determine the choice of the second material. However, it is generally contemplated that appropriate second materials include natural and synthetic polymers, various metals and metal alloys, naturally occurring materials, textile fibers, glass and ceramic materials, sol-gel materials, and all reasonable combinations thereof. However, it is generally preferred that the second material is at least in part permeable to a liquid and/or a gas, or shaped into a form that is permeable to a liquid and/or a gas (e.g., in form of a fabric, filter, porous cover, etc.). It should also be understood that the ratio of the carbonaceous material to the second material may vary considerably, and typical ratios will be between 0.001 to 99.999 to 99.999 to 0.001, and more typically between 1 to 99 and 99 to 1. The proper ratio is typically dependent on the particular use, and a person of ordinary skill in the art will readily determine desirable ratios without undue experimentation.

Contemplated carbonaceous materials may be embedded within (i.e., at least a portion of the material is at least partially enclosed) the second material. One typical manner of embedding may be in form of a mixture where contemplated materials are intimately admixed with the second material, and wherein that second material may be hardened or otherwise rigidified to at least temporarily retain the carbonaceous material. In such manners, the carbonaceous material may be admixed with a sol-gel material from which the solvent is subsequently removed and which may further be cured or otherwise treated to further harden the second material. Alternatively, and especially where the carbonaceous material is derivatized, it is contemplated that the second material may form a covalent with the derivatized carbonaceous material. Similarly, a crosslinker or other intermediary compound may be added to link contemplated carbonaceous material to the second material. Thus, where contemplated materials are embedded, a medium surrounding the embedded carbonaceous material may or may not have direct access to the carbonaceous material. Embedding of the carbonaceous materials may provide particularly advantageous properties to a device, and among other contemplated uses, such devices may be employed as conductors of electricity, conductors of heat, as material of manufacture where mechanical stability is desired, etc.

In other aspects of the inventive subject matter, contemplated carbonaceous materials may be enclosed within the second material (i.e., substantially all [>98 wt %] of the material is disposed within a cavity formed by the second material). In such configurations, additional materials may be admixed to or otherwise combined with the carbonaceous material. The second material may be configured as a bag, pouch, box, or other retainer, that is most preferably configured to allow influx and efflux of a liquid and/or a gas. Therefore, in some embodiments, contemplated devices may be configured as a flow through filter, or as a conductor of electricity or heat, which is optionally surrounded by an insulating material.

Where desirable, contemplated carbonaceous materials may also be coated onto the second material, wherein the coating may be done in numerous manners, including spray coating from or dip coating in a solution that includes the carbonaceous material. Alternatively, electrostatic coating, or even use of an intermediary material (e.g., high- or low tack adhesive) is contemplated. Furthermore, and especially where the carbonaceous material is derivatized, it should be recognized that the material may also be covalently coupled to the second material.

Among other uses of contemplated devices, it is generally preferred that the devices are employed in a manner that allows use of the particular advantages of the carbonaceous non-porous material. For example, as contemplated carbonaceous materials exhibit substantial sorption capacity towards numerous hydrocarbons and other compounds, especially contemplated devices include filters (e.g., flow-through, static, etc.), detectors, electron emitters, electric conductors (e.g., as an electrode material), heat conductors, etc. Therefore, in some exemplary aspects of the inventive subject matter, contemplated non-porous carbonaceous materials can be integrated into existing filters, and especially contemplated filters include cigarette filters. Here the non-porous carbonaceous material may be admixed with commonly used filter material, or may the non-porous carbonaceous material may be disposed at least upstream of a filter (as viewed from a smoker) that retains the non-porous carbonaceous material. Alternatively, or additionally, contemplated non-porous carbonaceous material may also be included into a combustion material to absorb hydrocarbonaceous materials formed at their site of formation. Such added material can then be filtered in conventional manner. Therefore, contemplated filters particularly include residential, commercial, and integrated air filters that receive indoor ambient and/or outdoor ambient air, and that produce a purified air (preferably indoor) that is reduced in at least one of a hydrocarbon, a volatile organic compound, and a chemical warfare agent (e.g., Vx, mustard gas, soman, etc.). Typically, but not necessarily, the material that retains the non-porous carbonaceous material includes a fibrous filter (e.g., from textile and/or paper) commonly used for air filtration, or a HEPA filter commonly used for air filtration.

In another example, the non-porous carbonaceous material may also be included into a filter cartridge (or other retaining structure) for beverages, wherein the cartridge may be disposed in a drinking straw, a bottle top, a flow-through filter (e.g., Britta filter), or in-line in a beverage (or water) transporting conduit. Thus, in such examples, the non-porous carbonaceous material is typically embedded, or enclosed in a cavity. Consequently, industrial and residential filters using such materials are specifically contemplated, wherein contemplated filters remove at least one of bad taste, one or more hydrocarbons, volatile organic compounds (VOC), and metal ions. In other exemplary aspects, the non-porous carbonaceous material is coated or embedded in a flow-through filter (or material to be retained by such filter). Among other embodiments, it is contemplated that the non-porous carbonaceous material is coupled to a coffee filter (e.g., integral with the filter material, or between two layers of filter material). Most preferably, the non-porous carbonaceous material in such coffee filters is present in an amount effective to reduce the undesirable taste of burnt roast products or otherwise undesirable taste components. Alternatively, or additionally, the non-porous carbonaceous material may also be added to the roasted beans or coffee grounds.

In yet additional contemplated aspects, the non-porous carbonaceous material may also be employed as a sorbent and/or antibacterial agent in a fluid-permeable container that is in contact with a fluid from food item (e.g., meat, produce, or fruit). In such embodiments, it is particularly preferred that at least a fraction of the carbonaceous material coated with an antibacterial compound or composition. For example, contemplated non-porous carbonaceous materials may be coated with silver (most preferably from a gas phase), and all silver deposition techniques are deemed suitable for use herein. Among other methods, CVD, PVD, or electrodeposition are contemplated, wherein the amount of silver is typically less than 5 wt %, more typically less than 1 wt %, and most typically less than 0.1 wt % of the carbonaceous material. Further aspects, embodiments, uses, and compositions are described in our copending U.S. patent applications with the Ser. Nos. 11/007,698, 11/007,612, and 11/007,614 (all filed Dec. 7, 2004), and U.S. patent application with the title “Compositions and Methods for Medical Use of Graphene-Containing Compositions” (filed Dec. 22, 2004), all of which are incorporated by reference herein.

Thus, specific embodiments and applications of compositions and methods for contact devices with nanostructured materials have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A device comprising:
a non-porous carbonaceous material other than a carbon nanotube in which the smallest dimension is less than 100 nm; and
a second material associated with the carbonaceous material such that the second material retains at least a portion of the carbonaceous material on or in the second material.

2. The device of claim 1 wherein the smallest dimension is less than 50 nm.

3. The device of claim 1 wherein the smallest dimension is less than 10 mm.

4. The device of claim 1 wherein the non-porous carbonaceous material comprises at least 0.1 wt % graphene.

5. The device of claim 1 wherein the non-porous carbonaceous material is embedded within the second material.

6. The device of claim 5 wherein the second material is selected from the group consisting of a sol-gel material, a synthetic polymer, a natural polymer, glass, and a metal.

7. The device of claim 5 wherein the second material is permeable to at least one of a liquid and a gas, and wherein the device is optionally configured for contact with a food item.

8. The device of claim 5 wherein the device is configured as at least one of a flow-through filter for a potable liquid and a flow-through filter for an inhaled gaseous composition.

9. The device of claim 1 wherein the non-porous carbonaceous material is enclosed within the second material.

10. The device of claim 9 wherein the second material is selected from the group consisting of a fabric, a synthetic polymer, a natural polymer, and a metal.

11. The device of claim 9 wherein the second material is permeable to at least one of a liquid and a gas.

12. The device of claim 9 wherein the device is configured as at least one of a flow-through filter for a potable liquid and a flow-through filter for an inhaled gaseous composition.

13. The device of claim 1 wherein the non-porous carbonaceous material is coated onto the second material.

14. The device of claim 11 wherein the second material is selected from the group consisting of a semiconductor, a synthetic polymer, a natural polymer, and a metal.

15. A filter comprising a non-porous carbonaceous material other than a carbon nanotube in which the smallest dimension is less than 100 nm, wherein a second material retains the carbonaceous material while the filter is in contact with at least one of a gas and a liquid.

16. The filter of claim 15 wherein the carbonaceous material comprises a graphene.

17. The filter of claim 16 wherein the second material is selected from the group consisting of a synthetic polymer, a natural polymer, a fabric, and a metal.

18. The filter of claim 17 wherein the second material at least partially encloses the carbonaceous material.

19. The filter of claim 15 wherein the gas comprises at least one of atmospheric air and cigarette smoke.

20. The filter of claim 15 wherein the liquid comprises at least one of water, coffee, and tea.
